(19) United States
(12) Patent Application Publication
(10) Pub. No.: US 2007/0260707 A1
(43) Pub. Date: Nov. 8, 2007

(54) Method and Apparatus for Providing Web Services Using Preference Information

(75) Inventors: Kang Chan Lee, Daejeon-city (KR); Won-Suk Lee, Daejeon-city (KR); Jong-Hong Jeon, Daejeon-city (KR); Seung Yun Lee, Daejeon-city (KR); Min-Kyo In, Daejeon-city (KR); In-Dong Jang, Daejeon-city (KR); Tae-Wan Yoo, Daejeon-city (KR)

Correspondence Address: LAHIVE & COCKFIELD, LLP, ONE POST OFFICE SQUARE, BOSTON, MA, 02109-2127, US

(73) Assignee: ELECTRONICS AND TELECOMMUNICATIONS RESEARCH INSTITUTE, DAEJEON (KR)

(21) Appl. No.: 11/792,979

(22) PCT Filed: Oct. 14, 2005
(86) PCT No.: PCT/KR05/03434

§ 371 Date: Jun. 13, 2007

(30) Foreign Application Priority Data
Dec. 13, 2004 (KR) 10-2004-0104919

(51) Int. Cl. G06F 15/16

(52) U.S. Cl. 709/217

(57) ABSTRACT

Provided is a method and apparatus for providing web services by which the performance of web services is improved and exchanges of a large quantity of messages are effectively supported. The method includes: preparing the preference information, which pre-describes information required by a web services provider, to provide web services requested by a web services requestor, and the web services provider interacting with the preference information to minimize the number of messages exchanged between the web services requestor and the web services provider.

### TECHNICAL FIELD

The present invention relates to a method and apparatus for providing web services by which the performance of web services is improved and exchanges of a large quantity of messages are effectively supported.

### BACKGROUND ART

Web services are provided by three main entities i.e., a web services requestor, a web services provider, and a web services registry, and use an extensible markup language (XML)-based simple object access protocol (SOAP) and a web service description language (WSDL). Web services use XML-based protocols based on various transfer protocols such as a hypertext transfer protocol (HTTP), a file transfer protocol (FTP), a simple mail transfer protocol (SMTP), etc. The size of XML-based message is several to tens of times larger than that of conventional binary type protocols. In processing of the XML, an XML message is analyzed to check validity thereof, and information desiring in an application is generated as an accessible type of data in an XML parser. Such XML processing time greatly deteriorates web services.

To improve the performance of web services, a binary XML approach that reduces the size of the XML message by changing the XML message into a binary type message is under development.

### DISCLOSURE OF INVENTION

### Technical Problem

The present invention provides a method and apparatus for providing preference-based web services by which the performance of web services is improved and exchanges of a large quantity of messages are effectively supported in a mobile environment.

### TECHNICAL SOLUTION

According to an aspect of the present invention, there is provided a method of providing web services using preference information, the method comprising: preparing the preference information, which pre-describes information required by a web services provider, to provide web services requested by a web services requestor; the web services requester requesting the web services for the web services provider; and the web services provider interacting with the preference information when messages are exchanged between the web services requestor and the web services provider to provide the requested web services, to minimize the number of messages exchanged between the web services requester and the web services provider.

According to another aspect of the present invention, there is provided an apparatus for providing web services using preference information, the apparatus comprising: a preference generator receiving from a web services requester information necessary for providing web services to generate preference information; a preference storage unit storing the generated preference information; a message processor receiving a message from the web services requester and converting the received message into data in a format suitable for a web services protocol; and a preference processor making the web services provider interact with the preference information when messages are exchanged between the web services requestor and the web services provider to provide web services requested from the web services requester, to minimize the number of messages exchanged between the web services requester and a web services provider.

### ADVANTAGEOUS EFFECTS

The present invention minimizes interactions between a web services requestor and an intermediary using preference information estimated from WS-CDL files, thereby efficiently improving the performance of web services.

### DESCRIPTION OF DRAWINGS

The above and other features and advantages of the present invention will become more apparent by describing in detail embodiments thereof with reference to the attached drawings in which:

FIG. 1 illustrates a conceptual constitution of web services;

FIG. 2 illustrates types of message exchanges between a web services requester and a web services provider;

FIG. 3 illustrates types of preference-based message exchanges between a web services requestor and a web services provider according to an embodiment of the present invention;

FIG. 4 illustrates a conceptual procedure of generating preference information;

FIG. 5 is a flowchart of a method of generating the preference information;

FIG. 6A illustrates an example of mobile web services using preference information, and FIG. 6B illustrates an another example of mobile web services using intermediary-based preference information;

FIG. 7 illustrates an exemplary use of preference-based web services in a home networking environment; and

FIG. 8 illustrates a system for providing web services according to an embodiment of the present invention.

### BEST MODE

### Mode for Invention

The present invention will now be described more fully with reference to the accompanying drawings in which embodiments of the present invention are shown.

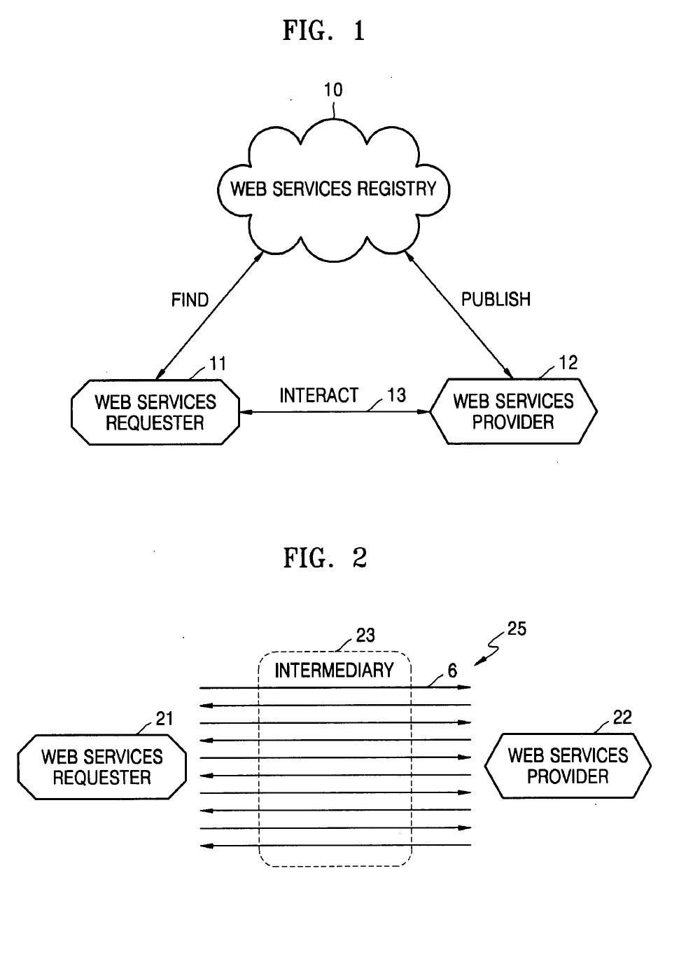

FIG. 1 illustrates a conceptual constitution of web services and includes a web services registry 10, a web services requestor 11, and a web services provider 12.

Interface information including a web service description language (WSDL) regarding web services provided by the web services provider 12 is published to the web services registry 10. The web services requester 11 finds the desired web services in the web services registry 10, and receives interface information required to use the web services. The web services requestor 11 receives desired web services from the web services provider 12 using the interface information. The web services registry 10, the web services requester 11, and the web services provider 12 use a simple object access protocol (SOAP)-based message. A lot of interactions 13 occur between the web services requestor 11 and the web services provider 12. In such a case, SOAP-based messages are exchanged.

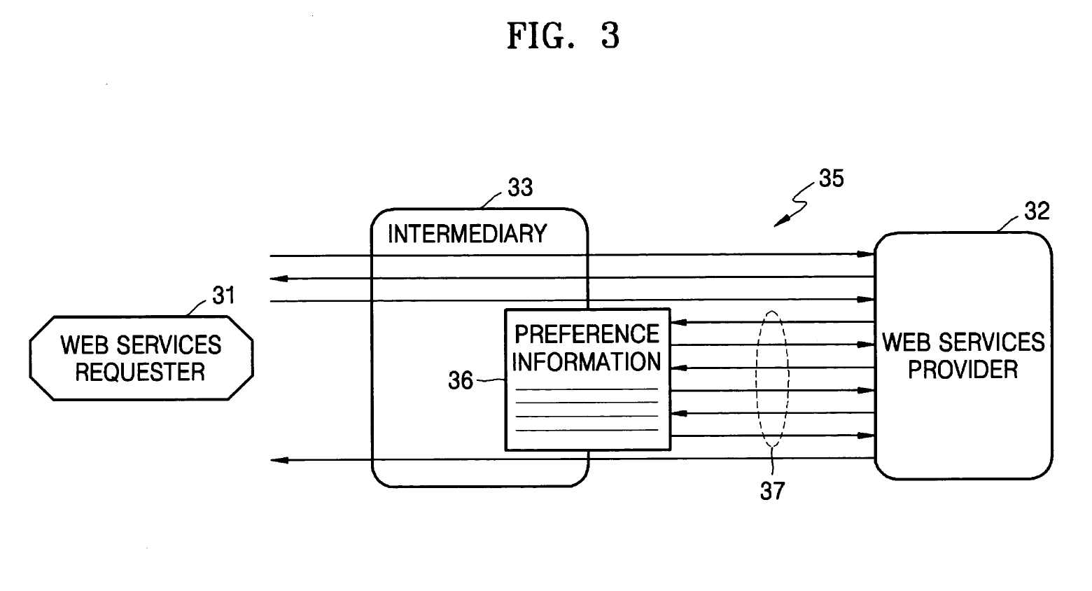

FIG. 2 illustrates types of message exchanges between a web services requestor 21 and a web services provider 22. Referring to FIG. 2, in the web services, message exchanges between the web services requestor 21 and the web services provider 22 may be directly performed or performed via an intermediary 23 that performs a protocol function on the web services therebetween. The intermediary 23, which is a constituent element interposed between the web services requestor 21 and the web services provider 22, intercepts a request from the web services requestor 21 and transmits the request to the web services provider 22, and intercepts a response from the web services provider 22 and transmits the response to the web services requestor 21.

The ordinary web services use extensible markup language (XML)-based SOAP messages, which take a lot of time to transmit and process messages. In particular, since a data transmission speed and computing power of mobile devices in mobile web services are quite lower than those of general PCs, frequent exchange of SOAP messages 25 between the web services requester 21 and the web services provider 22 results in deterioration of the web services. Also, web services provided in a home networking environment based on information-using appliances or a ubiquitous environment using a variety of small devices have similar problems to the mobile web services. Research for applying the web services to the home networking environment and the ubiquitous environment has been recently conducted, such that the web services can be likely applied to the entire IT environment.

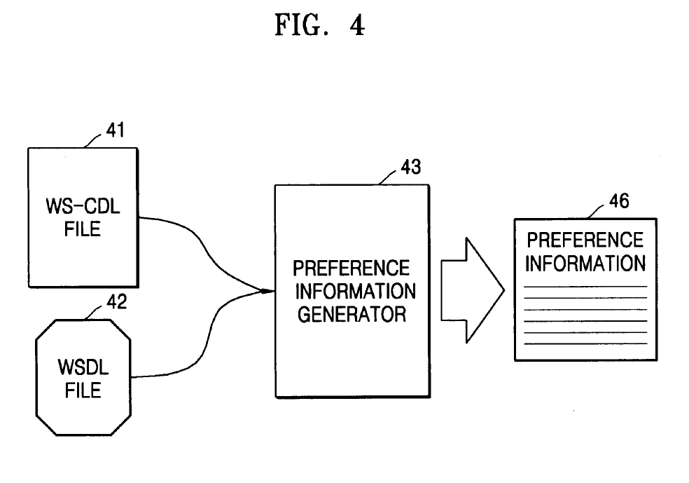

FIG. 3 illustrates types of preference-based message exchanges between a web services requestor and a web services provider according to an embodiment of the present invention, when the web services requester 31 finds desired web services and enjoys the desired web services of the web services provider 32.

An intermediary 33 includes preference information 36 that pre-describes information required by the web services provider 32 when the web services provider 32 provides the web services requested by the web services requestor 31. If the web services requester 31 requests the web services to the web services provider 32, the web services provider 32 performs interactions 37 with the preference information 36 when messages are exchanged between the web services requester 31 and the web services provider 32 in order to provide the desired web services, so that the number of exchanges of messages 35 between the web services requester 31 and the web services provider 32 is minimized.

The types of preference-based message exchanges illustrated in FIG. 3 reduces the number of messages exchanged between the web services requester 31 and the web services provider 32 as compared with the type of message exchanges illustrated in FIG. 2. Also, information requested by the web services provider 32 is provided by the preference information 36 instead of the web services requester 31. The preference information 36 pre-describes information likely required by the web services provider 32 and provides the information to the web services provider 32 at an appropriate time when the web services are used.

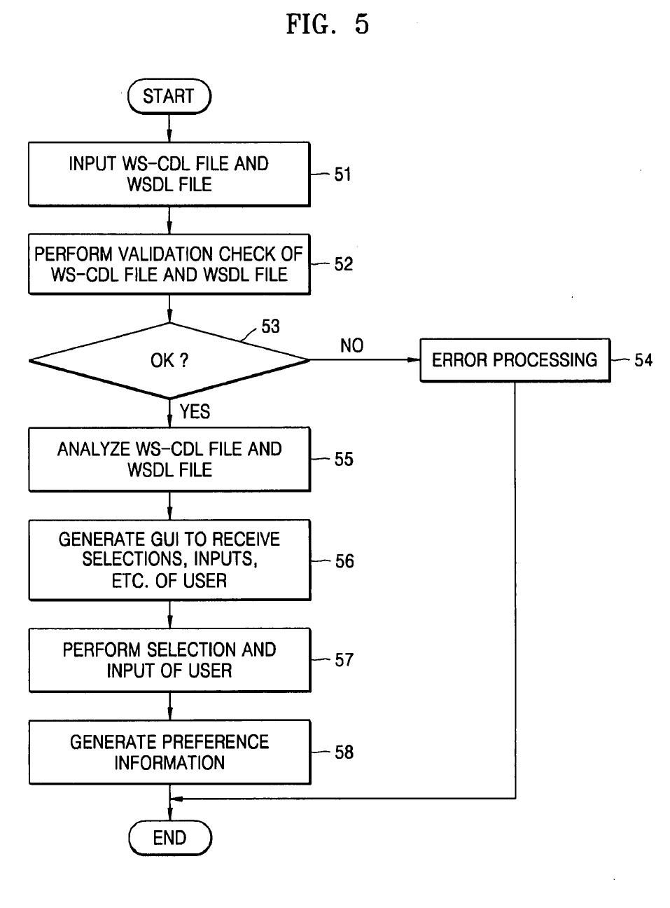

FIG. 4 illustrates a conceptual procedure of generating preference information. Referring to FIG. 4, a preference information generator 43 generates preference information 46 based on a web services choreography description language (WS-CDL) file 41 and a web services description language (WSDL) file 42. A description language similar to WS-CDL can be used instead of WS-CDL.

The WS-CDL is an XML-based language that describes detailed information on interactions between web services-based entities. The preference information 46 is generated based on the WSDL, which describes information on messages exchanged between the entities described in WS-CDL files and web services interface information on the entities.

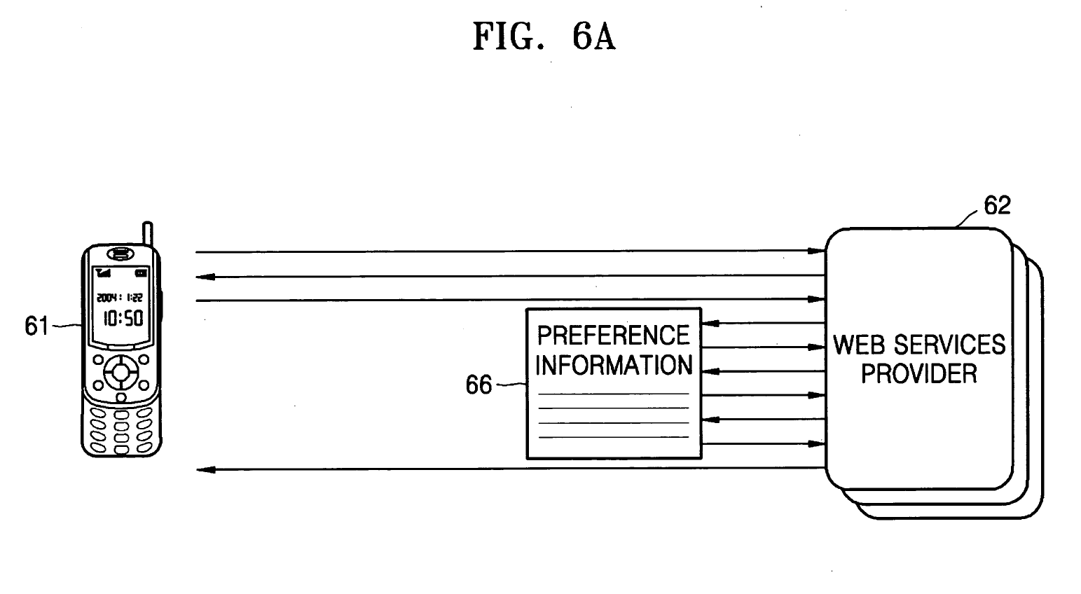

FIG. 5 is a flowchart of a method of generating the preference information. Referring to FIG. 5, a WS-CDL file and a WSDL file are received (Operation 51). The received WS-CDL and WSDL files are XML-based formats, which requires a validation check of the WS-CDL and WSDL files (Operation 52). If it is determined that the WS-CDL and WSDL files have a problem (Operation 53), since the preference information cannot be generated, an error procedure is performed (Operation 54) and no further operations are performed. If it is determined that the WS-CDL and WSDL files have no problem (Operation 53), the WS-CDL and WSDL files are analyzed (Operation 55). After completing the analysis, a graphic user interface (GUI) is generated that pre-selects or pre-inputs information on selections and inputs for which users are requested when web services are provided by a web services provider (Operation 56). Selections and inputs desired by users are performed based on what the GUI provides (Operation 57) and the preference information is generated (Operation 58). A description language having the same purpose can be used instead of the WS-CDL.

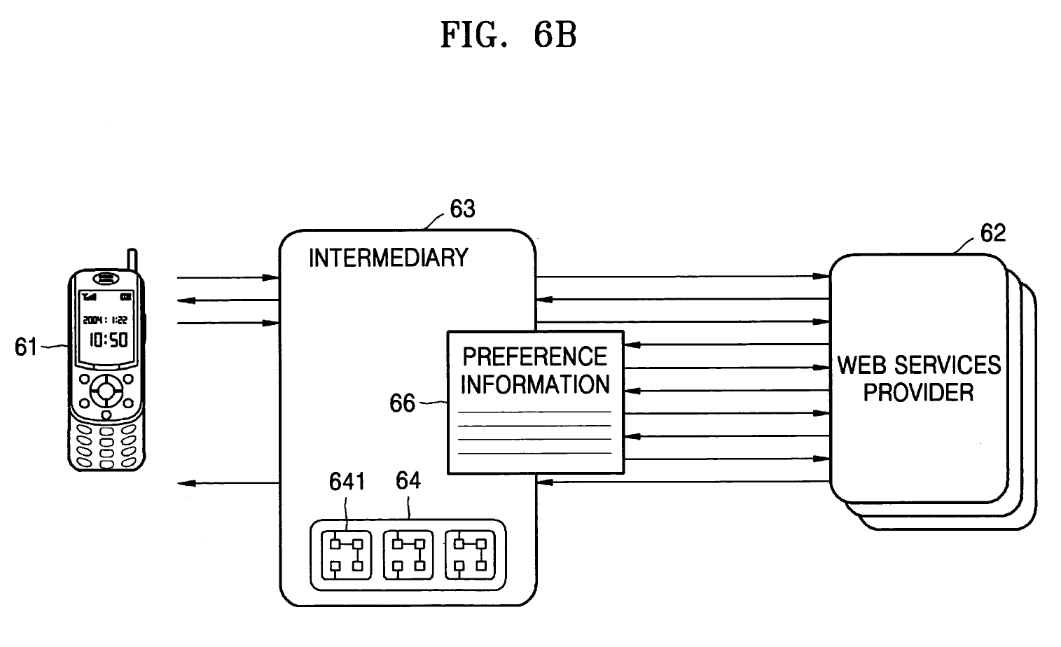

FIG. 6A illustrates an example of mobile web services using preference information. Referring to FIG. 6A, a mobile device 61 directly exchanges messages with a web services provider 62. Since the data transmission speed and computing power of the mobile device are quite lower than those of general PCs, frequent exchanges of SOAP messages between the web services requestor and the web services provider results in deteriorating the mobile web services. Therefore, the preference information 66-based mobile web services can greatly improve the performance of the mobile web services.

The mobile device 61 generates and stores the preference information 66 of desired web services and provides the preference information 66 along with web services provided by the web services provider 62, if necessary, thereby minimizing the number of messages exchanged between the mobile device 61 and the web services provider 62.

FIG. 6B illustrates an example of mobile web services using intermediary-based preference information. Referring to FIG. 6B, an intermediary 63 includes a WS-CDL library 64, which is a collection of WS-CDL files 641. The intermediary 63 includes a tool for generating preference information by interacting with a mobile device 61. Thus, when new web services are opened, preference information on the new web services can be generated. The intermediary 64 serves as a web services requestor to support mobile web services and improve the speed of executing the mobile web services.

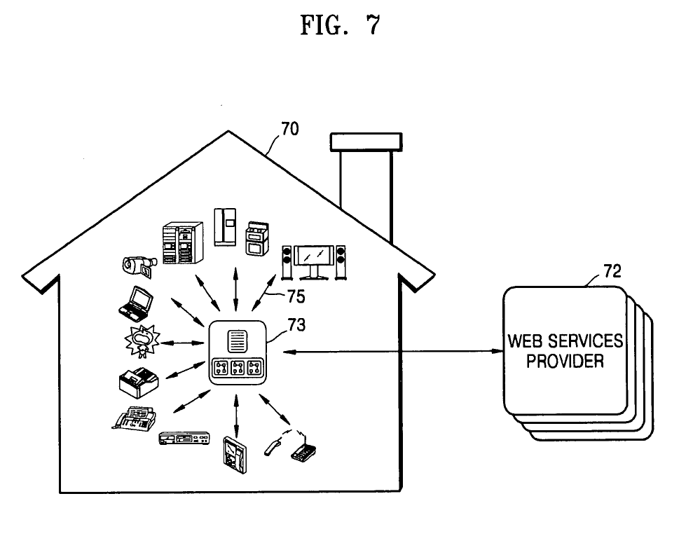

FIG. 7 illustrates an exemplary use of preference-based web services provided by a web services provider 72 in a home networking environment 70. Referring to FIG. 7, an intermediary 73 for a home network includes a WS-CDL library used in an interaction service scheme between information appliances and Internet services. The intermediary 73 includes a tool for generating preferences based on WS-CDL files, thereby providing an environment for an efficient exchange of messages. Information appliances and the intermediary 73 perform a SOAP 73-based communication. The actual SOAP 73 may be a transmission control procedure (TCP), a user datagram protocol (UDP), a hypertext transfer protocol (HTTP), etc.

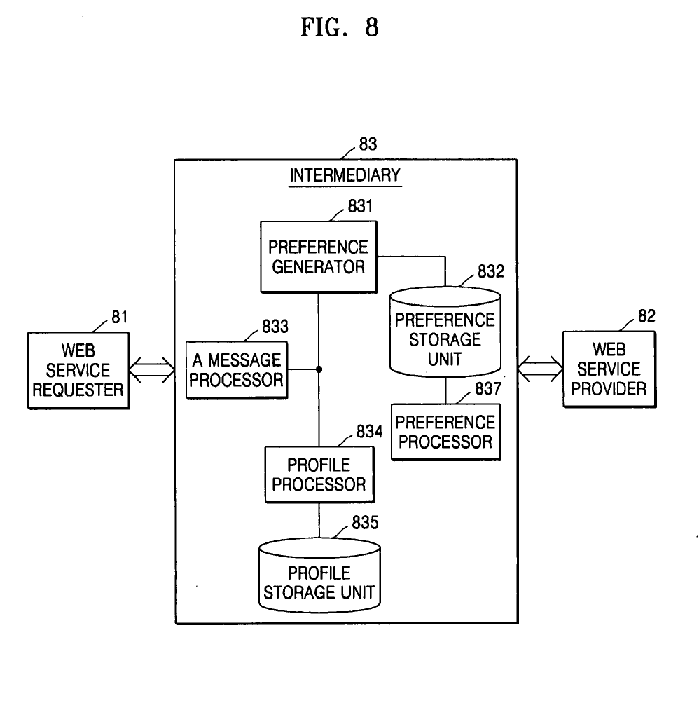

FIG. 8 illustrates a system for providing web services according to an embodiment of the present invention. Referring to FIG. 8, an intermediary 83 includes a preference generator 831 that receives information necessary for providing the web services from a web services requester 81 and generates preference information, a preference storage unit 832 that stores the generated preference information, a message processor 833 that receives a message from the web services requestor 81 and converts the received message into data in a format suitable for a web services protocol, and a preference processor 837 that interacts with a web services provider 82 using the preference information to minimize the number of messages exchanged between the web services requestor 81 and the web services provider 82 while providing the web services.

The intermediary 83 includes a variety of WS-CDL application modules to be shared with the web services requestor 81, requests the preference information used to interact with the web services provider 82 to the web services requestor 81 and generates the preference information. The intermediary 83 executes the web services using the preference information, and provides a result obtained by executing the web services to the web services requestor 81, thereby minimizing interactions between the web services requestor 81 and the intermediary 83/web services provider 82.

Since most mobile devices do not support web services protocols such as the SOAP, the HTTP, etc., it is necessary to convert messages between the web services protocol and a general mobile network protocol. The message processor 833 receives a message from a mobile device using the web services and converts the received message into a format suitable for the target.

In particular, since mobile devices have limited hardware/software resources, an interaction interface is important. Therefore, the intermediary 83 further includes a profile storage unit 835 that stores profile information of mobile devices such as the size and the resolution of a display panel, a software platform version, a browser type and version, etc., and a profile processor 834 provides the mobile devices with the message suitably converted for a device of the web services requestor 81 based on the profile information of a device of the web services requester 81.

Meanwhile, since the mobile network costs a great deal and has a slow data speed, its requires a compression/binary conversion mechanism, and since the mobile device has a low network connection as compared with a wired environment, it requires a caching mechanism.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the present invention is defined not by the detailed description of the invention but by the appended claims, and all differences within the scope of the present invention will be construed as being included in the present invention.

### INDUSTRIAL APPLICABILITY

As described above, the present invention minimizes interactions between a web services requestor and an intermediary using preference information estimated from WS-CDL files, thereby efficiently improving the performance of web services.

Also, the present invention minimizes the number of preference-based messages exchanged between the web services requestor and a web services provider, thereby overcoming deterioration caused by frequent exchanges of XML messages. The present invention can be applied to web services in almost all fields, including a mobile web services environment and a ubiquitous web services environment.

1. A method of providing web services using preference information, the method comprising:
preparing the preference information, which pre-describes information required by a web services provider, to provide web services requested by a web services requestor;
the web services requester requesting the web services for the web services provider; and
the web services provider interacting with the preference information when messages are exchanged between the web services requester and the web services provider to provide the requested web services, to minimize the number of messages exchanged between the web services requestor and the web services provider.

2. The method of claim 1, wherein the preference information is generated based on information on messages exchanged between entities and web services interface information on the entities.

3. An apparatus for providing web services using preference information, the apparatus comprising:
a preference generator receiving from a web services requester information necessary for providing web services to generate preference information;
a preference storage unit storing the generated preference information;
a message processor receiving a message from the web services requestor and converting the received message into data in a format suitable for a web services protocol; and
a preference processor making the web services provider interact with the preference information when messages are exchanged between the web services requestor and the web services provider to provide web services requested from the web services requester, to minimize the number of messages exchanged between the web services requestor and a web services provider.

4. The apparatus of claim 3, further comprising:
a profile storage unit storing profile information of a device of the web services requestor; and
a profile processor providing the message suitably converted for the device of the web services requester based on the profile information of the device of the web services requestor.
